(19) United States
(12) Patent Application Publication
(10) Pub. No.: US 2012/0121214 A1
(43) Pub. Date: May 17, 2012

(54) ROLLER BEARING METHOD AND APPARATUS

(75) Inventor: Jon Juhlin, Eugene, OR (US)

(73) Assignee: Johnson Crushers International, Eugene, OR (US)

(21) Appl. No.: 13/297,928

(22) Filed: Nov. 16, 2011

Related U.S. Application Data
(60) Provisional application No. 61/414,843, filed on Nov. 17, 2010.

(51) Int. Cl. F16C 33/58; B21D 53/10; F16C 33/46

(52) U.S. Cl. 384/564; 384/574; 29/898.04

(57) ABSTRACT

Embodiments herein generally provide a pin-guided roller bearing utilizing an interference fit, e.g., a shrink fit and/or press fit, to strengthen the connection between the pins and the cage, which may increase the durability of the cage. Various embodiments generally include a pin-guided cage and a plurality of roller elements coupled to the cage, wherein the pins are coupled to the cage by an interference fit. The roller bearing may further include a top race and a bottom race, coupled to opposite sides of the roller elements. The roller bearing may generally facilitate the movement of the top race relative to the bottom race while subject to a substantial load on the toprace.

### CROSS REFERENCE TO RELATED APPLICATIONS

The present application claims priority to U.S. Provisional Patent Application No. 61/414,843, filed Nov. 17, 2010, entitled “Roller Bearing Method and Apparatus,” the entire disclosure of which is hereby incorporated by reference in its entirety.

### TECHNICAL FIELD

Embodiments herein relate to the field of bearings, and, more specifically, to roller bearings.

### BACKGROUND

The rollers in rolling element bearings are typically aligned and separated by means of a cage. Many bearings use a one-piece cage with internal pockets to guide the rollers. However, the number and length of the rollers is limited by the space required by the cage. To counteract this, pin-guided roller bearings have been developed in which the cage includes pins that pass through the rollers, allowing the use of more rollers for a given bearing size. One such arrangement for a cylindrical thrust roller bearing utilizes a roller with an axial hole and a cage with rings disposed on either end of the roller and a pin that passes through the axial hole and is secured at both ends to the two rings.

Typically, the pins are secured to the rings by a threaded, welded, or swaged connection. However, during operation of the bearings there is a tendency for the two rings to move and/or vibrate relative to one another in a manner that subjects the pins to bending and shear stresses concentrated at the connection point between the pins and the cage. Furthermore, this problem is exacerbated in situations where the bearing is subjected to a substantial load and/or a high impact load that may not load the bearing uniformly on all the rollers. For example, when a cylindrical thrust roller bearing is used as a pedestal mount for heavy machinery, such as a rock crusher, threaded or welded joints between the pin and the cage rings are susceptible to fatigue failures when subjected to cyclical bending stresses.

### BRIEF DESCRIPTION OF THE DRAWINGS

Embodiments will be readily understood by the following detailed description in conjunction with the accompanying drawings and the appended claims. Embodiments are illustrated by way of example and not by way of limitation in the figures of the accompanying drawings.

FIG. 1A illustrates an exploded isometric view of a roller bearing in accordance with various embodiments;

FIG. 1B illustrates a cross-sectional view of a roller bearing in accordance with various embodiments;

FIG. 2A illustrates an exploded isometric view of a roller bearing in accordance with various embodiments;

FIG. 2B illustrates a cross-sectional view of a roller bearing in accordance with various embodiments;

FIG. 3A illustrates an exploded isometric view of a roller bearing in accordance with various embodiments;

FIG. 3B illustrates a cross-sectional view of a roller bearing in accordance with various embodiments;

FIG. 4A illustrates an exploded isometric view of a cylindrical radial bearing in accordance with various embodiments; and

FIG. 4B illustrates a cross-sectional view of a cylindrical radial bearing in accordance with various embodiments.

### DETAILED DESCRIPTION OF DISCLOSED EMBODIMENTS

In the following detailed description, reference is made to the accompanying drawings which form a part hereof, and in which are shown by way of illustration embodiments that may be practiced. It is to be understood that other embodiments may be utilized and structural or logical changes may be made without departing from the scope. Therefore, the following detailed description is not to be taken in a limiting sense, and the scope of embodiments is defined by the appended claims and their equivalents.

Various operations may be described as multiple discrete operations in turn, in a manner that may be helpful in understanding embodiments; however, the order of description should not be construed to imply that these operations are order dependent.

The description may use perspective-based descriptions such as up/down, back/front, and top/bottom. Such descriptions are merely used to facilitate the discussion and are not intended to restrict the application of disclosed embodiments.

The terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

For the purposes of the description, a phrase in the form “NB” or in the form “A and/or B” means (A), (B), or (A and B). For the purposes of the description, a phrase in the form “at least one of A, B, and C” means (A), (B), (C), (A and B), (A and C), (B and C), or (A, B and C). For the purposes of the description, a phrase in the form “(A)B” means (B) or (AB) that is, A is an optional element.

The description may use the terms “embodiment” or “embodiments,” which may each refer to one or more of the same or different embodiments. Furthermore, the terms “comprising,” “including,” “having,” and the like, as used with respect to embodiments, are synonymous, and are generally intended as “open” terms (e.g., the term “including” should be interpreted as “including but not limited to,” the term “having” should be interpreted as “having at least,” the term “includes” should be interpreted as “includes but is not limited to,” etc.).

With respect to the use of any plural and/or singular terms herein, those having skill in the art can translate from the plural to the singular and/or from the singular to the plural as is appropriate to the context and/or application. The various singular/plural permutations may be expressly set forth herein for sake of clarity.

Embodiments herein generally provide a pin-guided roller bearing utilizing an interference fit to strengthen the connection between the pins and the cage and increase the durability of the cage. Various embodiments generally include a pin-guided cage and a plurality of roller elements coupled to the cage, wherein the pins are coupled to the cage by an interference fit. The roller bearing may further include a top race and a bottom race, coupled to opposite sides of the roller elements. The roller bearing may generally facilitate the movement of the top race relative to the bottom race while subject to a substantial load on the top race. Various embodiments herein are designed such that the cage is more durable than and outlives/outlasts the races/rollers.

In various embodiments, the pin-guided cage may include an inner ring, an outer ring, and a plurality of guide pins. The inner ring and outer ring may each have a plurality of receiving holes disposed along the annular surface of the ring for coupling the guide pins to the ring. Similarly, the roller elements may each have an axial hole through which the guide pins may be inserted. In some embodiments, the roller elements may include a bushing lining the axial hole to facilitate rotation of the rollers. Each guide pin may be inserted through the axial hole of a roller element and be coupled to the receiving holes of the inner ring and outer ring such that the roller element and guide pin are each generally disposed between the inner ring and outer ring. The guide pins may form a slip fit with the axial holes in the roller elements to couple the roller elements to the cage while allowing the roller elements to rotate during operation of the bearing.

In various embodiments, the guide pins may be coupled to at least one of the inner ring or outer ring with an interference fit. For purposes of describing embodiments herein, an interference fit may include a shrink fit, a press fit, and/or a friction fit, but does not include a welded, threaded, or swaged connection. To create the interference fit, the diameter of the guide pins at the ends of the guide pins may be larger than the diameter of the receiving holes in the cage ring when not joined together. When the end of the guide pin is placed in the receiving hole, the interference fit that is created may subject the guide pins and cage inner ring and outer ring to large pre-stress compressive loads. The pre-stressed loads on the pins may counter and reduce the magnitude of tensile stresses on the connection point between the guide pin and cage inner ring and/or outer ring during operation of the roller bearing. This may substantially increase the durability of the roller bearing compared to roller bearings with pin-guided cages where the guide pins are coupled to the cage by another type of connection, such as a threaded connection or weld.

In various embodiments, the interference fit between the pins and the cage may be created by any suitable method, such as by force, by cooling the pins to shrink the pin diameter prior to creating the fit, by heating the cage rings to expand the diameter of the receiving holes prior to creating the fit, by providing a roughened surface on an end portion of the pin and/or in the receiving hole to increase the effectiveness of the fit, and/or any combination of the above methods and/or other suitable methods.

For example, the interference fit may be created by applying force to the pin to press the end of the pin into the receiving hole of the cage ring, e.g., a press fit. The force may be applied by a hydraulic press, an arbor press, and/or any other suitable mechanism. Since the diameter of the end of the guide pin is greater than the diameter of the receiving hole prior to fitting, when the end of the guide pin is forced into the receiving hole, an interference fit is created between the guide pin and the cage ring. This interference fit subjects the guide pin to large pre-stress compressive loads at the connection point between the guide pin and the cage ring. The large pre-stress compressive loads may counteract the tensile stresses present at the connection point between the guide pin and cage ring when the pin is subjected to tensile stress resulting from vibration and/or distortion of the cage.

In some embodiments, the interference fit may be created, facilitated, and/or improved by cooling the pins to shrink the diameter of the ends of the pins prior to pressing the pins into the receiving holes. For example, the pins may be cooled to a low temperature by a coolant, such as liquid nitrogen. The cooled pins may then be pressed into the receiving holes in the inner ring and/or outer ring. The low temperature of the pins created by the coolant may shrink the diameter of the pins and allow the ends of the pins to fit more easily in the receiving holes in the inner ring and/or outer ring. As the pins return to ambient temperature, the pins expand, creating an interference fit between the pin and the ring and increasing the compressive load on the connection between the pin and the ring. The diameter of the ends of the guide pins at low temperature may or may not be less than the diameter of the receiving holes in the cage ring. As such, in some embodiments, the guide pins may be cooled to low temperature in addition to being press fit by force as described above. For example, the guide pins may be cooled to low temperature and then hydraulically pressed into the receiving holes of the cage inner ring and/or outer ring.

Similarly, in some embodiments, the interference fit may be created, facilitated, and/or improved by heating the ring to high temperature prior to pressing the guide pins into the receiving holes of the ring. Heating the ring to high temperature may cause the diameter of the receiving holes to increase, making it easier to press the guide pins into the receiving holes. Once the guide pins are pressed into the receiving holes, the ring may be allowed to cool to ambient temperature, causing the diameter of the receiving holes to shrink and creating and/or improving the interference fit between the guide pins and the receiving holes. The diameter of the receiving holes at high temperature may or may not be greater than the diameter of the end of the guide pins at ambient temperature. As such, in some embodiments, the ring may be heated to high temperature in addition to the guide pins being press fit by force as described above. For example, the ring may be heated to high temperature and then the guide pins may be hydraulically pressed into the receiving holes of the ring.

For the purposes of describing embodiments herein, the term “low temperature” generally refers to a temperature reduced below ambient temperature, such as below 0 F, −100 F, −200 F, or below −300 F. The term “ambient temperature” refers generally to the temperature of the surroundings or room temperature. The term “high temperature” generally refers to a temperature elevated above ambient temperature, such as above OF, 100 F, 200 F, or above 300 F.

In some embodiments, the end of the pins and/or the inside of the receiving holes may include a roughened surface, such as a splined, serrated, knurled, and/or sandblasted surface. The roughened surface may be used to create and/or improve the interference fit.

In some embodiments, the guide pin may have an open axial seam, e.g., a roll pin and/or spring pin. The open axial seam may close as the guide pin is pressed into the receiving holes in the ring.

In order to form an interference fit between the pins and the ring, the pins may have a diameter prior to fitting that is larger than the diameter of the receiving holes in the ring. Prior to fitting, the pins may have an allowance, i.e. a relative difference between the diameter of the pin and the diameter of the receiving hole. The allowance may vary depending on the dimensions of the pins, and the desired degree of the interference-fit.

In various embodiments, the pins, inner ring, and outer ring may be manufactured of any suitable material, such as steel, brass, and/or other suitable materials. The pins, inner ring, and outer ring may each be manufactured of the same material or of different materials.

During operation, the guide pins may be subjected to centrifugal loads and/or forces from the rotational speed of the bearing. To prevent radial migration of the guide pins, an annular retaining ring may be installed around the perimeter of the cage outer ring. In some embodiments, multiple retaining rings may be installed. Alternatively, or in addition to the retaining ring, the outer ring of the cage may include receiving holes for receiving the guide pins that do not extend all the way through the outer ring. In these embodiments, the outer ring itself may prevent radial migration of the guide pins. Furthermore, in some embodiments, the guide pins may include a head having a larger diameter on the inner side of the inner ring to prevent radial migration.

In various embodiments, the cage may include both an inner ring and an outer ring. In these embodiments, the pins may be disposed radially from the inner ring to the outer ring and the pins may pass through the axial holes in the rollers such that the rollers are disposed between the inner ring and outer ring. The pins may be coupled to one or both of the inner ring and outer ring by an interference fit as described above. In some embodiments, the inner ring and the outer ring may be combined into the same piece, i.e., they may be connected by a means other than the guide pins. In other embodiments, the cage may include only one of an inner ring or an outer ring. In these embodiments, the rollers may be held in place in the bearing by the upper race, the lower race, and/or the guide pin.

In various embodiments, the guide pins may have a constant diameter. The diameter of the guide pins may be sized to create an interference fit with the inner ring and/or outer ring and a slip fit with the roller elements. That is, the diameter of the guide pins at ambient temperature may be greater than the diameter of the ring receiving holes and less than the diameter of the roller axial holes.

In other embodiments, the diameter of the guide pins may vary along the length of the guide pins. The diameter of the guide pins at the ends of the guide pins may be sized to create an interference fit with the inner ring and/or outer ring of the cage. The diameter of the central portion of the guide pins may be sized to create a slip fit with the roller elements. Having guide pins with a varying diameter may aid in assembly of the bearing by preventing the guide pins from passing too far through the ring receiving holes during formation of the interference fit. In some embodiments, the guide pins may include a head of larger diameter on one end in order to facilitate the positioning of the guide pins and prevent migration of the guide pins during operation.

In some embodiments, a first end portion of the guide pin may have a larger diameter than a second end portion and a central portion of the guide pin. Such a configuration may aid in the manufacturing process of the bearing. For example, the inner ring and outer ring may be held in position by a clamp or other mechanism while the pins are inserted. The rollers may be placed between the inner ring and outer ring such that the axial hole in the rollers aligns with the receiving holes on the inner ring and outer ring. The second end portion of the guide pin may then be inserted through the receiving hole of the inner ring from inside the inner ring, i.e., radially from the center of the inner ring toward the outer ring. The guide pin may be easily inserted until the first end portion of the guide pin, that has a larger diameter, reaches the receiving hole on the inner ring. The first end portion of the guide pin may then be hydraulically pressed into the receiving hole of the inner ring, creating an interference fit between the guide pin and the inner ring. At the same time, the second end portion may or may not be pressed into the receiving hole in the outer ring to create an interference fit. To allow for an interference fit in both the inner ring and outer ring with guide pins having ends of different diameters, the receiving holes in the inner ring and the receiving holes in the outer ring may have different diameters. In other embodiments, the interference fit may be created by inserting the pins through the receiving holes in the outer ring from the outside, e.g. toward the inner ring, and then hydraulically pressed into the receiving holes in the outer ring and/or inner ring.

In some embodiments, the roller bearing may include two guide pins for each roller. A first guide pin may form an interference fit with the inner ring of the cage and may extend into the axial hole of the roller. A second guide pin may form an interference fit with the outer ring of the cage and extend into the axial hole of the roller. In some such embodiments, the roller may have a first axial hole for the first guide pin on a first side of the roller and a second axial hole for the second guide pin on a second side of the roller. The first axial hole and the second axial hole may not extend all the way through the roller. The first axial hole and the second axial hole may or may not be co-axial with one another.

In some embodiments, the roller bearing may further include structural members coupling the inner ring and the outer ring separately from the guide pins. The structural members may provide further resistance to relative motion between the inner ring and outer ring and may facilitate manufacturing of the bearing.

In various embodiments, the rollers may be of any desirable shape, such as generally cylindrical or generally spherical. In some embodiments, the diameter of the rollers may be tapered such that the diameter increases or decreases from one end to the other. In some embodiments, the axial holes of the rollers may include a bushing which may facilitate the rotation of the rollers.

Although many of the embodiments discussed above describe a roller thrust bearing, the bearing may be of any desirable configuration. For example, the bearing may be a v-flat thrust bearing, a cylindrical thrust bearing, a cylindrical radial bearing, a tapered radial roller bearing, a spherical roller radial or thrust bearing, a linear roller bearing, or any other roller bearing that employs a pin-guided cage for roller alignment and separation. Similarly, the bearing may include multiple rollers coaxially aligned within the cage, e.g., multiple rollers coupled to the same guide pin. Regardless of the bearing configuration, coupling the guide pins to the cage through an interference fit may increase the durability and fatigue resistance of the cage.

In certain failure tests performed, guide pins having an interference fit with a cage substantially outperformed guide pins having a threaded connection or welded connection with the cage. The guide pins used in the tests were made of 4140 quenched and tempered steel. Each guide pin tested had a diameter at its central portion of 0.550 inches. The prototype pin had a 0.002″ interference fit with the cage. That is, the diameter of the end of the prototype pin was 0.002″ larger than the diameter of the receiving hole. A second test pin was connected through a welded connection and a third test pin was connected through a threaded connection. The pins were cantilevered at the end of a rotating motor shaft with a weight hanging near the end of the pin to produce a bending moment. As the motor rotated, the pin was subjected to reverse bending stress. The speed of the motor and weight of the test weight were held constant throughout the tests. The imposed bending stress was deliberately large to accelerate the time to failure. The motor was operated to rotate at 400 rotations per minute and the number of cycles until failure was recorded. The welded pin failed after a maximum of 67,511 cycles of the motor, while the threaded pin failed after a maximum of 348,311 cycles of the motor. A pin with an interference fit in accordance with embodiments herein did not fail after 8,686,000 cycles. Therefore, this testing provides evidence that the interference fit may substantially increase the strength and durability of the guide pins used in roller bearings.

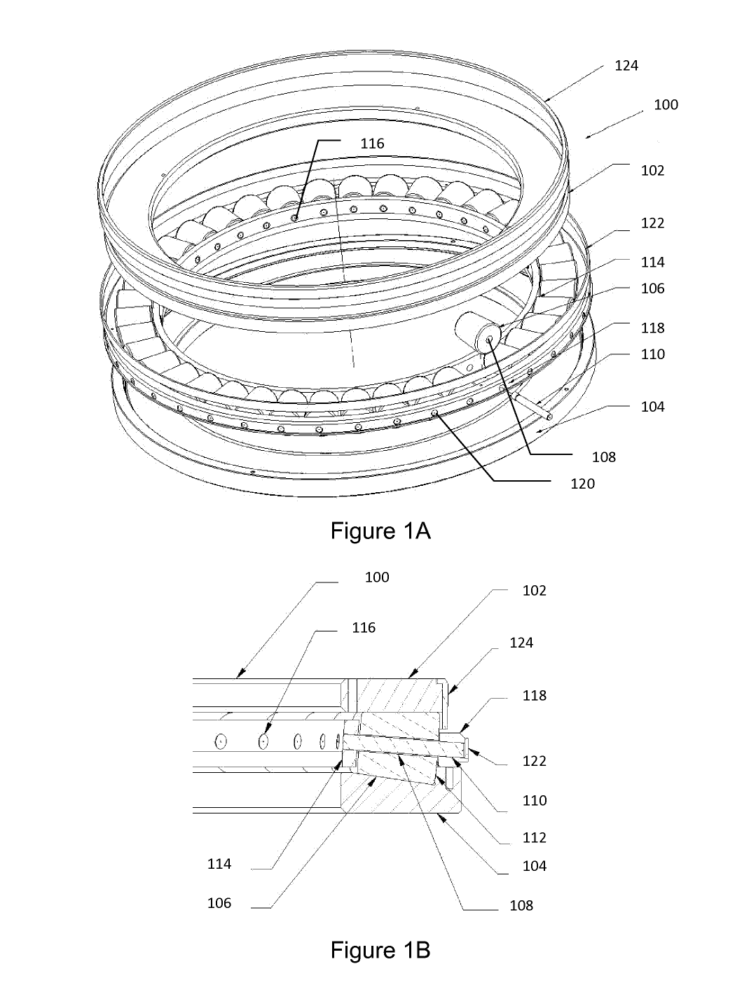

FIG. 1A illustrates an exploded isometric view and FIG. 1B illustrates a cross-sectional view of an example of a roller bearing in accordance with various embodiments. Bearing 100 includes a top race 102 and a bottom race 104 which are concentric to each other. Rollers 106 each have an axially bored hole 108 through which a guide pin 110 may be inserted. The outer end 112 of rollers 106 is guided by bottom race 104 and guide pins 110. The cage includes an inner annular ring 114 with bored receiving holes 116 and an outer annular ring 118 with bored receiving holes 120 for an interference fit, e.g., shrink fit and/or press fit, with guide pins 110. Guide pins 110 form a slip fit with rollers 106 and an interference fit with inner annular ring 114 and outer annular ring 118. Bearing 100 may further include an annular retaining ring 122 to prevent guide pins 110 from radial migration and/or an oil deflector band 124. In an embodiment, oil deflector band 124 deflects or redirects oil spray to a lower or alternative location.

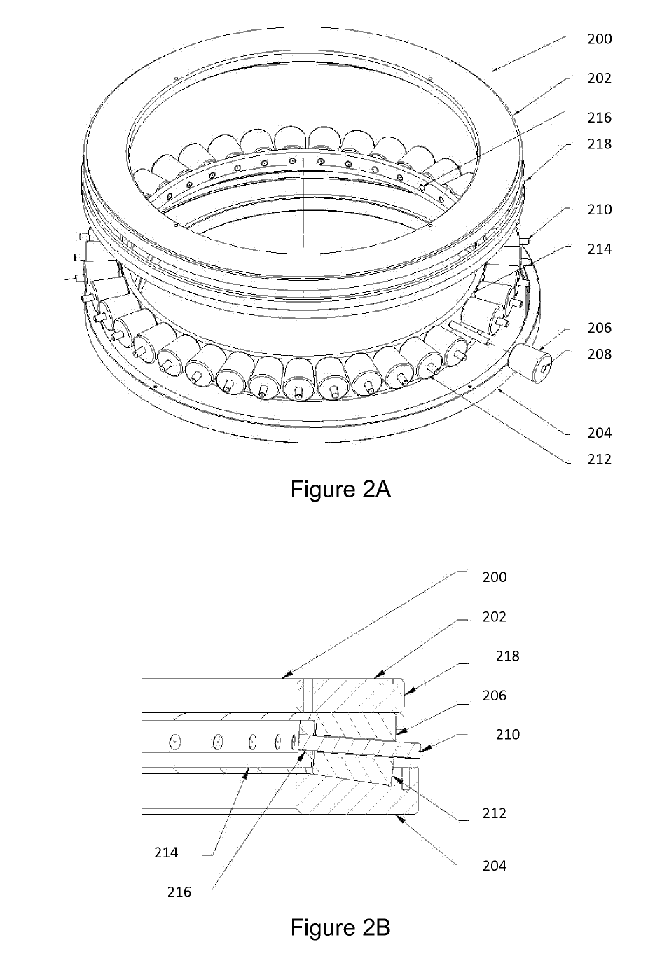

FIG. 2A illustrates an exploded isometric view and FIG. 2B illustrates a cross-sectional view of an example of a roller bearing with a cage that includes an inner ring but not an outer ring, in accordance with various embodiments. Bearing 200 includes a top race 202 and a bottom race 204 which are concentric to each other. Rollers 206 each have an axially bored hole 208 through which a guide pin 210 may be inserted. The outer end 212 of rollers 206 is guided by bottom race 204 and by the cage guide pins 210. The cage includes an inner annular ring 214 with bored receiving holes 216 for an interference fit, e.g., a shrink and/or press fit, with guide pins 210. Guide pins 210 have a slip fit with rollers 206 and an interference fit with inner annular ring 214. Bearing 200 may also include an oil deflector band 218 configured to redirect oil spray. Additionally, in some embodiments, guide pins 210 may have a larger diameter head on the inner side of inner annular ring 214 to prevent radial migration.

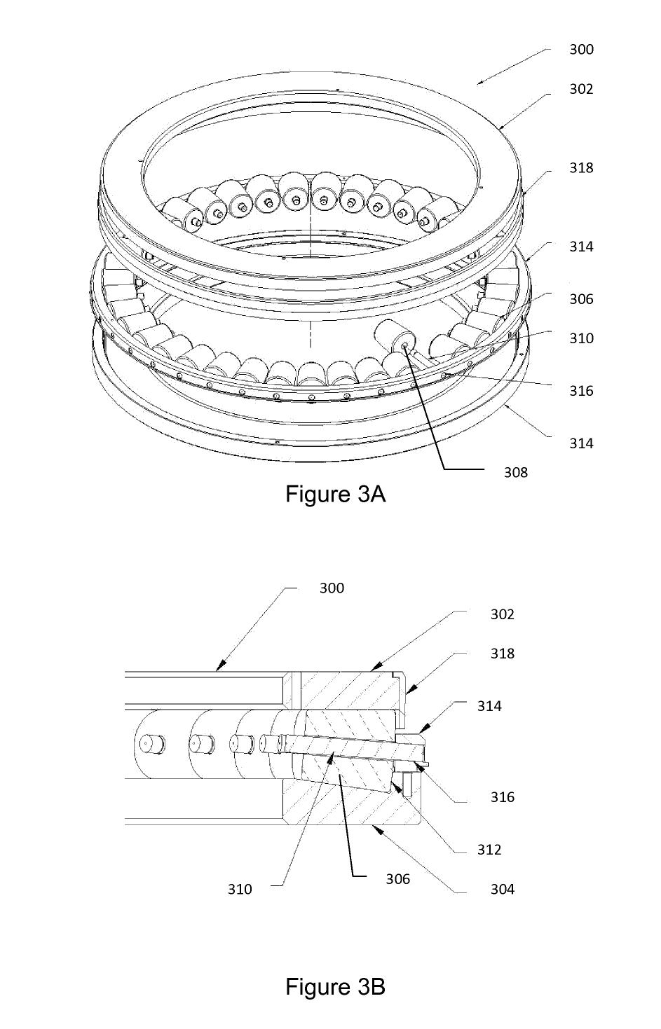

FIG. 3A illustrates an exploded isometric view and FIG. 3B illustrates a cross-sectional view of an example of a roller bearing with a cage that includes an outer ring but not an inner ring, in accordance with various embodiments. Bearing 300 includes a top race 302 and a bottom race 304 which are concentric to each other. Rollers 306 each have an axially bored hole 308 through which a guide pin 310 may be inserted. The outer end 312 of rollers 306 is guided by the bottom race 304 and by the cage guide pins 310. The cage includes an outer annular ring 314 with bored receiving holes 316 for an interference fit, e.g., a shrink and/or press fit, with guide pins 310. Guide pins 310 may have a slip fit with the rollers and an interference fit with the outer annular ring 314. Bearing 300 may further include an oil deflector band 318 to prevent exiting oil from spraying during operation.

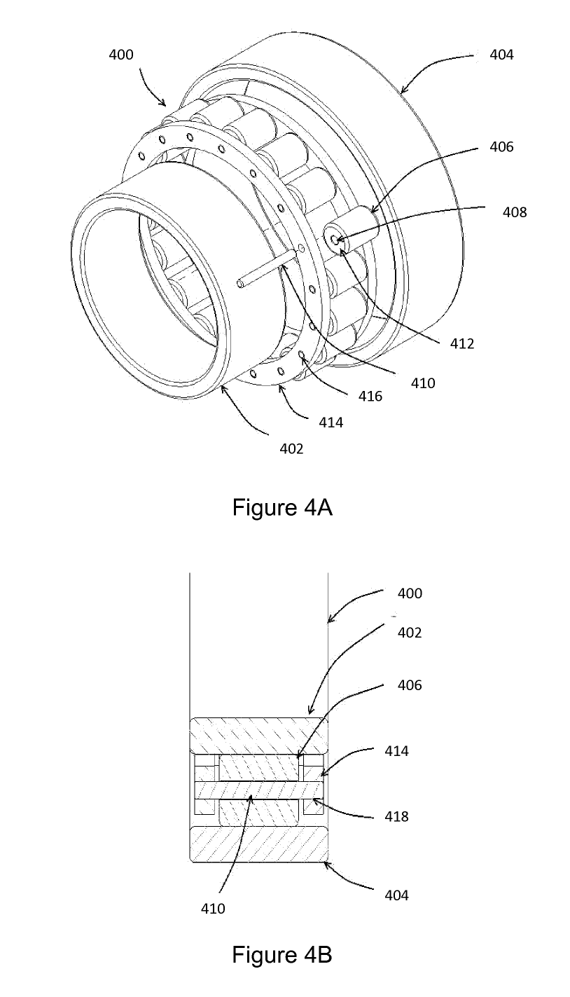

FIG. 4A is an exploded isometric view and FIG. 4B is a cross-sectional view of an example of a radial cylindrical roller bearing in accordance with various embodiments. Bearing 400 includes an inner race 402 and an outer race 404 which are concentric to each other. Rollers 406 each may have an axially bored hole 408 through which a guide pin 410 may be inserted. The ends 412 of rollers 406 are guided by guide pins 410 and the cage annular side plates 414. Cage annular side plates 414 have bored receiving holes 416 for an interference fit, e.g., a shrink and/or press fit, with guide pins 410. Guide pins 410 have a slip fit with rollers 406 and an interference fit 418 with cage annular side plates 414.

Although certain embodiments have been illustrated and described herein, it will be appreciated by those of ordinary skill in the art that a wide variety of alternate and/or equivalent embodiments or implementations calculated to achieve the same purposes may be substituted for the embodiments shown and described without departing from the scope. Those with skill in the art will readily appreciate that embodiments may be implemented in a very wide variety of ways. This application is intended to cover any adaptations or variations of the embodiments discussed herein. Therefore, it is manifestly intended that embodiments be limited only by the claims and the equivalents thereof.

What is claimed is:

1. A roller bearing, comprising:
at least one of an inner ring and an outer ring having a plurality of receiving holes disposed radially along an annular surface thereof;
a plurality of guide pins coupled to the receiving holes of at least one of the inner ring and the outer ring with an interference fit; and
a plurality of rollers having an axial hole, with the guide pins disposed through the axial hole of the rollers.

2. The roller bearing of claim 1, further comprising:
a top race coupled to a top side of the rollers; and
a bottom race coupled to a bottom side of the rollers.

3. The roller bearing of claim 1, further comprising both an inner ring and an outer ring.

4. The roller bearing of claim 1, wherein the guide pins include a central portion having a central portion diameter sized to form a slip fit with the axial hole of the rollers and at least one of a first end portion having a first end diameter sized to form an interference fit with the receiving hole of the inner ring and a second end portion having a second end diameter for forming an interference fit with the receiving hole of the outer ring, at least one of the first end diameter and second end diameter having a different diameter from the central portion diameter.

5. The roller bearing of claim 1, further comprising a retaining ring coupled to an outside surface of the outer ring to prevent radial movement of the guide pins.

6. The roller bearing of claim 1, wherein the receiving holes of the outer ring do not extend entirely through the outer ring.

7. The roller bearing of claim 1, wherein the interference fit between the guide pins and the at least one of the inner ring and the outer ring is accomplished by hydraulically pressing the guide pins into the receiving holes.

8. The roller bearing of claim 1, wherein the interference fit between the guide pins and the at least one of the inner ring and the outer ring is accomplished by cooling the guide pins to a low temperature with a coolant and pressing the guide pins into the receiving holes.

9. The roller bearing of claim 1, wherein the rollers include a bushing disposed in the axial hole of the rollers.

10. The roller bearing of claim 1, wherein the guide pins include at least one of a first end portion and second end portion that has a roughened surface.

11. The roller bearing of claim 10, wherein the roughened surface is created by at least one of splines, serrations, knurling, and sandblasting.

12. A roller bearing, comprising:
a cage having a plurality of receiving holes;
a plurality of rollers having an axial hole;
a plurality of guide pins, each guide pin forming a slip fit with the axial hole of a roller and forming an interference fit with at least one of the receiving holes of the cage.

13. The roller bearing of claim 12, wherein the rollers include a bushing disposed in the axial hole of the rollers.

14. The roller bearing of claim 12, wherein the bearing has a configuration selected from the group consisting of: a v-flat thrust bearing, a cylindrical thrust bearing, a cylindrical radial bearing, a tapered roller radial bearing, a spherical roller thrust bearing, a spherical roller radial bearing, and a linear roller bearing.

15. A method of manufacturing a roller bearing having a cage, a plurality of guide pins, and a plurality of rollers, comprising:
inserting a guide pin through an axial hole of a roller; and
pressing the guide pin into one of a plurality of receiving holes disposed on the cage to form an interference fit.

16. The method of claim 15, further comprising:
installing a top race on a top side of the rollers; and
installing a bottom race on a bottom side of the rollers.

17. The method of claim 15, wherein the cage includes an inner ring having a plurality of receiving holes and an outer ring having a plurality of receiving holes.

18. The method of claim 15, wherein the guide pins have a first end portion having a first end diameter and a second end portion having a second end diameter, the first end diameter being larger than the second end diameter.

19. The method of claim 18, wherein the cage includes an inner ring having a plurality of receiving holes and the method further comprises:
inserting the second end portion of the guide pin through the receiving hole of the inner ring of the cage;
inserting the second end portion of the guide pin through the axial hole of the roller;
forming an interference fit between the first end portion of the guide pin and the receiving hole of the inner ring of the cage.

20. The method of claim 19, wherein the interference fit between the first end portion of the guide pin and the receiving hole of the inner ring of the cage is formed by hydraulically pressing the first end portion of the guide pin into the receiving hole of the inner ring of the cage.
